(19) United States
(12) Patent Application Publication
(10) Pub. No.: US 2004/0177019 A1
(43) Pub. Date: Sep. 9, 2004

(54) Method for pooling commodity purchases

(76) Inventors: Vlado Slavov, Atlanta, GA (US); John H. Wengraf, Atlanta, GA (US)

Correspondence Address: Gregory S. Smith, P.O. Box 88148, Atlanta, GA, 30356, US

(21) Appl. No.: 10/382,205

(22) Filed: Mar. 5, 2003

(51) Int. Cl. G06F 17/60

(52) U.S. Cl. 705/36

(57) ABSTRACT

A method for producing a price index model is described, illustrated and claimed. The method includes the steps of setting up a customized price index, generating a periodic price index, calculating periodic call payouts and calculating periodic swap payouts. One aspect of the present invention is to optimize an entities spending for an entity having a plurality of geographically diverse facilities that purchase commodities.

### TECHNICAL FIELD

The present invention relates to commodity trading industry and, more particularly, to a method by which an entity, having operations in geographically diverse areas with each operation expending amounts of the commodity, can pool buying power of the various operations for the purchase or trade of commodities.

### BACKGROUND OF THE INVENTION

Today, many commodities are traded on the open market throughout the world. Typically, the commodities are consumed directly by a purchaser or they are re-sold to other buyers in the market. In both of these scenarios, a purchaser, or entity, may buy large amounts of commodities to be utilized or consumed in a number of different geographical locations. This is typically done by purchasing the commodities from each local market at a price dictated by each market. Usually an index is established in each market to guide and stabilize the purchase of commodities in that market. This is especially useful when an entity purchases many commodities over a period of time.

Purchasing a commodity typically takes place by an entity either buying at a spot price, the current market price at that time, or at a contract price, a pre-determined price over a period of time. When purchasing at a spot price, the purchaser may be able to take advantage of a low price at that time; however, if the price rises before the entity's next purchase, the entity is forced into paying the higher price. Therefore, many entities purchase commodities at a contract price for a period of time. A contract price guarantees the entities cost will never change; however, this price is typically more than the entity would pay if it were to buy at spot price.

Another factor in purchasing commodities is the type of market. Purchasing a commodity in a well-established market is much safer than purchasing in a small market that is not established. A well-established market will have a reliable index to guide an entity to make an informed purchase. Usually, with a reliable index, an entity can purchase a commodity at a contract price and actually pay less than if the entity were to pay at spot price over the same period of time. When purchasing a commodity in a non-established market with an unreliable index, the spot price is typically inflated and the entity is forced into buying long-term contracts at higher rates.

Recently, some commodity brokers have offered an option when buying commodities. The broker will sell an entity a commodity at spot price and additionally offer the entity to purchase an option to cap the cost of the spot price. The option will place a ceiling, or typically called a call strike price, on the amount the entity pays over a period of time. The options are usually effective for entities buying from only a couple of different markets, however, when an entity purchases from several different markets, it must buy an option from each market—this can become costly. In addition, if an entity buys an option from a market that is not established, the premium for the option may be very costly.

What is needed, therefore, is a geographical price index that takes an entity's typical usage and cost into account to equalize prices and thus, allow the entity to pool buying power of the various operations of the entity for the purchase or trade of commodities.

### SUMMARY OF THE INVENTION

The present invention is directed towards solving the aforementioned needs in the art, as well as other needs in the art, by providing an approach to purchasing commodities over a geographically diverse area in a plurality of geographically diverse areas.

One aspect of the present invention is a method for determining a price index model unique to a specific entity who buys commodities in a plurality of geographically diverse areas or who has a plurality of commodity consuming facilities that are geographically diverse. The unique aspect of this invention is finding an optimal call strike price for a given commodity such that there is a superior measure of savings using the price index model. In addition, once a call strike price is determined, the price index model is used to calculate periodic payouts when appropriate.

### BRIEF DESCRIPTION OF THE DRAWINGS

Other aspects, advantages and novel features of the invention will become more apparent from the following detailed description of exemplary embodiments of the invention when considered in conjunction with the accompanying drawings wherein:

FIG. 1 is a block diagram illustrating a system for implementing an exemplary embodiment of the present invention.

FIG. 2 is a flow diagram illustrating a method of producing a stack model according to an exemplary embodiment of the present invention.

FIG. 3 is a flow diagram illustrating a method of producing a price index model according to an exemplary embodiment of the present invention.

FIG. 4 is a flow diagram illustrating the payout calculations using a price index model according to an exemplary embodiment of the present invention.

### DETAILED DESCRIPTION

Turning now to the figures in which like numerals represent like elements throughout the several views, several exemplary embodiments of the present invention are described.

This invention can be applied to virtually any commodity market including but not limited to electric power, natural gas, grains, agricultural products, metals, petrochemicals, energy products such as heating oil, jet fuel, crude oil and distillate products thereof, pulp and paper, plastics, integrated circuit chips such as Dynamic Random Access Memory (DRAM), and other traded commodities. The electric power industry is used as an exemplary embodiment of the present invention.

The present invention can be used to lower the cost, or at least provide protection against drastic cost changes, in the purchase of a commodity. This is accomplished by creating a tailored price index that includes all, or a significant number of an entity's geographically diverse facilities. More specifically, the present invention is a price index for a particular entity having a plurality of geographically diverse facilities, wherein the price index is utilized to periodically calculate payouts to and from the entity based on a call strike price or a swap price. First, in a stack model, generating an appropriate call strike price or swap price using history data, current forward market data and contract terms. Second, in a price index model, generating a periodic price index using periodic load and periodic price data. Next, using the call strike price or swap price generated in the stack model and using the periodic price index, calculating periodic payouts to and from the entity.

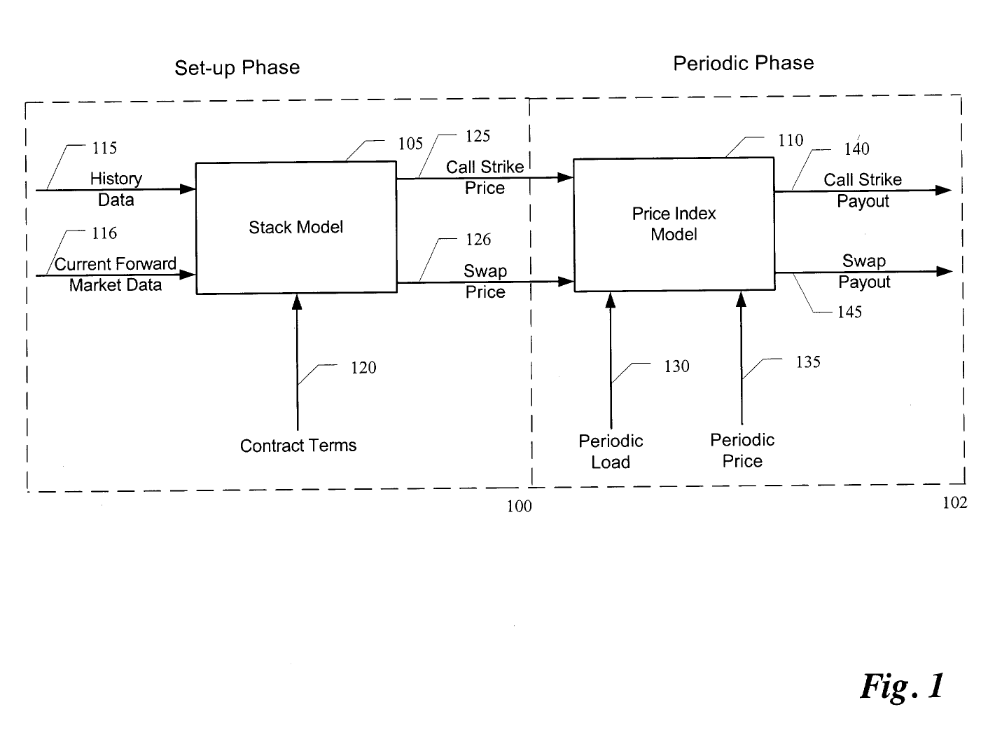

FIG. 1 is a block diagram illustrating an exemplary embodiment of the present invention. In FIG. 1, a set-up phase 100 containing a stack model 105 works in conjunction with a periodic phase 102 containing a price index model 110. In an exemplary embodiment, the set-up phase 100 occurs only once, at the onset of initiating a trade, to generate a call strike price 125 or a swap price 126, depending on what hedging instrument is considered by the entity. Therefore, the call strike price 125 or swap price 126 does not change. The stack model 105 incorporates history data 115, current forward market data 116 for a particular geographic area and contract terms 120 as well as other information to generate the call strike price 125 or swap price 126. Once the call strike price 125 or swap price 126 is generated in the set-up phase 100, it is utilized in the price index model 110 for processing. There, in the periodic phase 102, the price index model 110 performs periodic calculations using the call strike price 125 or swap price 126, a periodic load 130 and a periodic price 135. The price index model 110 generates a call strike payout 140 or a swap payout 145.

In another exemplary embodiment, the set-up phase 100 may occur at specified intervals, or at other specified times. Thus, the call strike price 125 or the swap price 126 may change accordingly. Those skilled in the art will appreciate that the application of the present invention can take many forms and functions and the examples provided herein are only used to illustrate a few of these possibilities. The scope of the present invention is not limited by these examples.

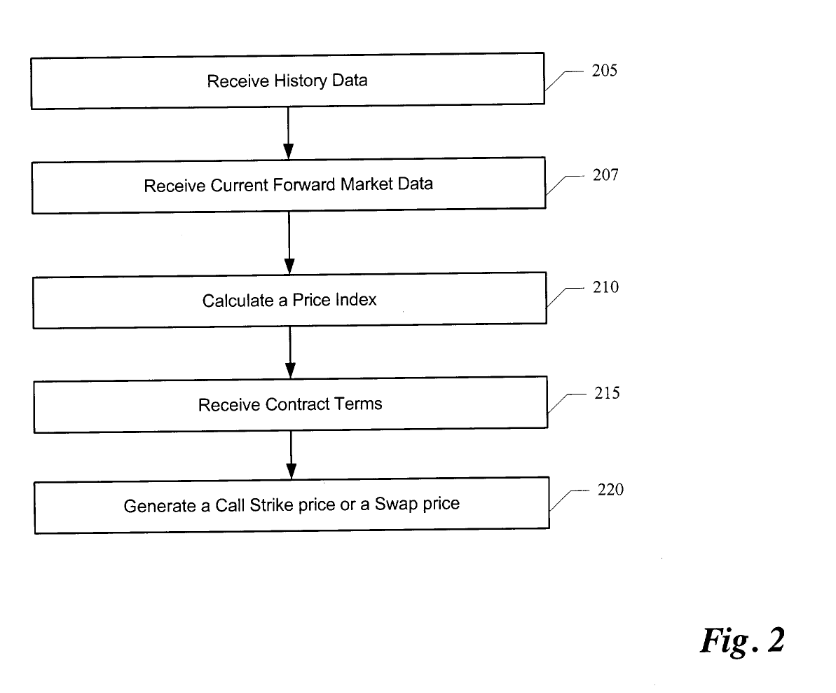

FIG. 2 is a flow diagram illustrating the operation of the stack model 105 according to an exemplary embodiment of the present invention. The details of the operation of the stack model 105 may vary among various embodiments of the present invention. However, in an exemplary embodiment, the first step of the stack model 105 is receiving history data at step 205. The history data includes, but is not limited to, a load history. The load history is based on load data over a period of time for an entity that buys commodities in a plurality of geographically diverse areas or that has a plurality of commodity consuming facilities that are geographically diverse.

The next step of the stack model 105 is receiving current forward market data, at step 207. The current forward market data includes, but is not limited to, forward market price data. The forward market price data is based on a forecast of price data for a future period of time for a particular geographic area. The forward market price data includes data for all geographic areas that an entity that buys commodities in a plurality of geographically diverse areas or that has a plurality of commodity consuming facilities that are geographically diverse.

The next step of the stack model 105 is calculating a price index, step 210, based upon the history data and the current forward market data. Step 210 is performed by the equation of:

$$I = \frac{\sum [ L \times P ]}{\sum L} ;$$

where

I is the price index;

L is the load data; and

P is the price data.

The price index encompasses the entities entire commodity portfolio across a plurality of geographically diverse areas. Thus, the price index is representative of the entities spending and usage trends and needs.

In an alternative exemplary embodiment, a group of geographically diverse facilities is selected from the entities plurality of geographically diverse facilities in response to the history data. The group may be selected for specific desired criteria or for some other reason. The group of geographically diverse facilities is then used in calculating the price index using the aforementioned equation. Furthermore, the calculation of the price index may be performed a plurality of times with different combinations of groups each time to facilitate the selection of an exemplary group.

The next step of the stack model 105 is receiving contract terms, at step 215. Contract terms refer to the terms of purchase contracts for the commodities that an entity negotiates with local commodity dealers. Contract terms may include, but are not limited to, purchase options, purchase prices, time periods, and other terms specified in a purchase contract.

Next, the price index and contract terms as well as other information are used to generate a call strike price or a swap price at step 220, thus, the call strike price or swap price is representative of the entities trends and needs. Those skilled in the art know many techniques for modeling and predicting trends. Such techniques are generally proprietary in that they give a trading company their advantage. Such techniques should be applied in the generation of the call strike price.

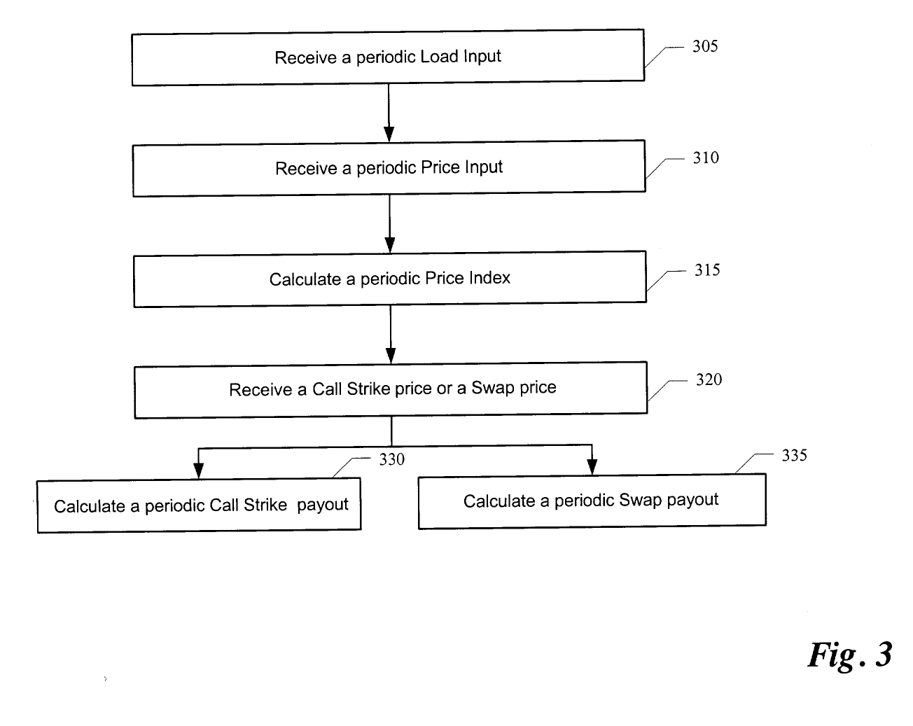

FIG. 3 is a flow diagram illustrating the operation of the price index model 110 according to an exemplary embodiment of the present invention. In an exemplary embodiment of the present invention, the first step of the price index model 110 is receiving a periodic load input at step 305. The periodic load input is based on load data over a period of time for an entity that buys commodities in a plurality of geographically diverse areas or that has a plurality of commodity consuming facilities that are geographically diverse, taken at a periodic interval. The next step is receiving a periodic price input at step 310. Likewise, the price input is based on price data over a period of time for an entity that buys commodities in a plurality of geographically diverse areas or that has a plurality of commodity consuming facilities that are geographically diverse, taken at a periodic interval. The next step of the price index model 110 is calculating a periodic price index at step 315. Step 315 is performed by the equation of:

$${I}_{p} = \frac{\sum [ {L}_{p} \times {P}_{p} ]}{\sum {L}_{p}} ;$$

where

Iₚ is the periodic price index;

Lₚ is the periodic load input; and

Pₚ is the periodic price input.

The periodic price index encompasses the entities entire commodity portfolio across a plurality of geographically diverse areas. Thus, the periodic price index is representative of the entities spending and usage trends, taken at a periodic interval. In an exemplary environment, the periodic price index is calculated with all of the plurality of geographically diverse facilities. In an alternative exemplary embodiment, the periodic price index is calculated using a group of the geographically diverse facilities. The next step is receiving a call strike price or a swap price at step 320. The call strike price or swap price is received from the stack model 105 in the set-up phase 100. The next step is either calculating a periodic call strike payout, step 330, or calculating a periodic swap payout at step 335. The selection is determined by the entity and the commodity broker in the stack model 105. When a call option is selected, then the next step is calculating a periodic call strike payout, step 330. A call is a type of option that caps the cost of a commodity at a call strike price. For example, if the call strike price is $35 and a commodity price for Day 1 is $45, the entity will pay the $45 to the local dealer and receive $10, a call payout, from the seller of the call, thus capping the commodity price at the call strike price of $35. If, however, the commodity price for Day 1 is $25, the entity will pay $25, with a call payout of $0. Please note that the example was for one day, the present invention calculates a periodic call payout over a specified period, which may be one day or a plurality of days. Step 330 is performed by the equation of:

P_{c}=ΣLₚ×max{Iₚ−Sₛ,0};

where

P_{c} is the periodic call payout;

Lₚ is the periodic load input;

Iₚ is the periodic price index; and

Sₛ is the call strike price.

When a swap option is selected, the next step, after step 320, is calculating a periodic swap payout, step 335. A swap is a type of option that sets the price of a commodity at the swap price. For example, if a swap price is $35 and a commodity price for Day 1 is $25, the entity will pay $10 to the broker, a swap payout of −$10, thus paying $35 total. If however, the price for the commodity is $45, the entity will only pay $35 and the broker will pay $10, a swap payout of $10. Step 335 is performed by the equation of:

Pₛ=ΣLₚ×{Iₚ−S_{sw}};

where

Pₛ is said periodic swap payout;

Lₚ is said periodic load input;

Iₚ is said periodic price index; and

S_{sw} is said swap price.

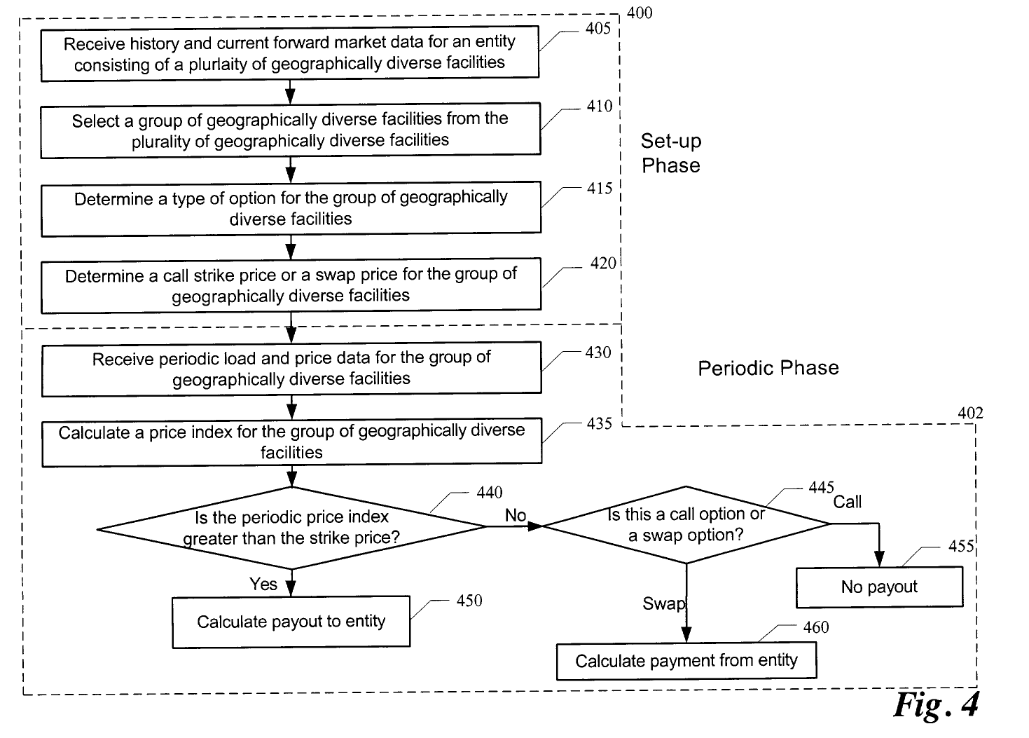

FIG. 4 is a flow diagram illustrating the calculation of a payout based upon a price index according to an exemplary embodiment of the present invention. FIG. 4 has two phases, a set-up phase 100 and a periodic phase 102. In an exemplary embodiment the set-up phase 100 is completed each renewal period and the periodic phase 102 occurs every periodic period. The renewal period will be determined by the broker and typically, it will be a longer amount of time than the periodic period. The first step is receiving history and current forward market data for an entity consisting of a plurality of geographically diverse facilities at step 405. The next step is selecting a group of geographically diverse facilities at step 410. Next, in step 415, the entity and broker determine the optimal type of option for the group of geographically diverse facilities based, at least in part, on the history and current forward market data. The next step is determining a call strike price or a swap price, depending on the option selected, for the group of geographically diverse facilities based, at least in part, on the history and current forward market data and contract terms at step 420. The next step, a periodic phase 102 step, receives periodic load and price data for the group of geographically diverse facilities at step 430. The next step is calculating a price index for the group of geographically diverse facilities at step 435. Next, we determine if the periodic price index is greater than the call strike price or the swap price at step 440. If it is, then the next step is to calculate the payout to the entity at step 450. If it is not, then the next step is to determine if the option is a call option or a swap option at step 445. If it is a call option, there is no payout, step 455. If it is a swap option, then calculate the payment from the entity to the broker at step 460.

Although this disclosure describes our invention in terms of exemplary embodiments, the invention is not limited to those embodiments. Rather, a person skilled in the art will construe the appended claims broadly, to include other variants and embodiments of the invention, which those skilled in the art may make or use without departing from the scope and range of equivalents of the invention.

What is claimed is:

1. A method for generating a price index for the purchase of a commodity by an entity, said entity purchasing said commodities at a plurality of locations that are geographically diverse, the method comprising the steps of:
receiving a quantity input for each of said locations, each of said locations utilizing an expected quantity;
receiving a price input for each of said locations, each of said locations utilizing an expected price; and
generating a price index in response to receiving said quantity input and said price input for each of said locations.

2. The method of claim 1, wherein the step of generating said price index is performed by the equation of:
$$I = \frac{\sum [ L \times P ]}{\sum L} ;$$
where I is said price index;
L is said load input; and
P is said price input.

3. The method of claim 1, further comprising the steps of:
receiving a call strike price for said plurality of locations; and
calculating a payout in response to said call strike price and said price index.

4. The method of claim 3, wherein the step of calculating said payout further comprises the step of calculating a call strike payout.

5. The method of claim 4, wherein the step of calculating said call strike payout is performed by the equation of:
P_{c}=ΣL×max{I−Sₛ,0};
where P_{c} is said call strike payout;
L is said load input;
I is said price index; and
Sₛ is said call strike price.

6. The method of claim 1, further comprising the steps of:
receiving a swap price for said plurality of locations; and
calculating a payout in response to said swap price and said price index.

7. The method of claim 6, wherein the step of calculating said payout further comprises the step of calculating a swap payout.

8. The method of claim 7, wherein the step of calculating said swap payout is performed by the equation of:
Pₛ=ΣL×{I−S_{sw}};
where Pₛ is said swap payout;
L is said load input;
I is said price index; and
S_{sw} is said swap price.

9. A method for generating a price index for the purchase of electricity by an entity, said entity having a plurality of electric consuming facilities that are geographically diverse, the method comprising the steps of:
receiving history data for the plurality of electric consuming facilities, each electric consuming facility utilizing an expected load;
selecting a group of geographically diverse electric consuming facilities from said plurality of electric consuming facilities in response to said history data;
determining a call strike price for said group of geographically diverse electric consuming facilities based at least in part on said history data;
receiving a periodic load input for each facility within said group of geographically diverse electric consuming facilities;
receiving a periodic price input for each facility within said group of geographically diverse electric consuming facilities;
generating a periodic price index for said group of geographically diverse electric consuming facilities in response to receiving said periodic load input and said periodic price input; and
calculating a periodic payout in response to said call strike price and said periodic price index.

10. The method of claim 9, wherein the step of generating said periodic price index is performed by the equation of:
$${I}_{p} = \frac{\sum [ {L}_{p} \times {P}_{p} ]}{\sum {L}_{p}} ;$$
where Iₚ is said periodic price index;
Lₚ is said periodic load input; and
Pₚ is said periodic price.

11. The method of claim 9, wherein the step of calculating said periodic payout further comprises the steps of calculating a periodic call strike payout.

12. The method of claim 11, wherein the step of calculating said periodic call strike payout is performed by the equation of:
P_{c}=ΣLₚ×max{Iₚ−S,0};
where P_{c} is said periodic call payout;
Lₚ is said periodic load input;
Iₚ is said periodic price index; and
S is said call strike price.

13. The method of claim 9, wherein the step of calculating said periodic payout further comprises the steps of calculating a periodic swap payout.

14. The method of claim 13, wherein the step of calculating said periodic swap payout is performed by the equation of:
Pₛ=ΣLₚ×{Iₚ−S_{sw}};
where Pₛ is said periodic swap payout;
Lₚ is said periodic load input;
Iₚ is said periodic price index; and
S_{sw} is said swap price.

15. A method for reducing the cost of electric power by an entity, said entity having a plurality of electric consuming facilities that are geographically diverse, the method comprising the steps of:
negotiating electric prices for said plurality of facilities;
receiving history data for the plurality of electric consuming facilities;
selecting a group of geographically diverse consuming facilities from said plurality of electric consuming facilities in response to said negotiated prices and said history data;
determining a call strike price for said group of geographically diverse consuming facilities based at least in part on said history data;
determining a swap price for said group of geographically diverse consuming facilities based at least in part on said history data;
receiving a monthly price and load input for each of said group of geographically diverse consuming facilities;
calculating a monthly price index for said group of geographically diverse consuming facilities in response to said periodic price and load input;
calculating a monthly payout in response to said monthly price index.

16. The method of claim 15, wherein the step of calculating said monthly price index is performed by the equation of:
$${I}_{m} = \frac{\sum [ {L}_{m} \times {P}_{m} ]}{\sum {L}_{m}} ;$$
where Iₘ is said monthly price index;
Lₚ is said monthly load input; and
Pₚ is said monthly price.

17. The method of claim 15, wherein the step of calculating said monthly payout further comprises the steps of:
calculating a monthly call strike payout; and
calculating a monthly swap payout.

18. The method of claim 17, wherein the step of calculating the monthly call strike payout is performed by the equation of:
P_{mc}=ΣLₘ×max{Iₘ−S, 0};
where P_{mc} is said monthly call strike payout;
Lₘ is said monthly load input;
Iₘ is said monthly price index; and
S is said call strike price.

19. The method of claim 17, wherein the step of calculating the monthly swap payout is performed by the equation of:
Pₘₛ=ΣLₘ×{Iₘ−O}
where Pₘₛ is said monthly swap payout;
Lₘ is said monthly load input;
Iₘ is said monthly price index; and
S is said swap price.
